(19) United States
(12) Patent Application Publication
(10) Pub. No.: US 2005/0005467 A1
(43) Pub. Date: Jan. 13, 2005

(54) Measurement device for use with underground flow system and associated method

(76) Inventor: Johnathan S. Hannel, Indianapolis, IN (US)

Correspondence Address: BARNES & THORNBURG, 11 SOUTH MERIDIAN, INDIANAPOLIS, IN, 46204, US

(21) Appl. No.: 10/843,786

(22) Filed: May 12, 2004

Related U.S. Application Data
(60) Provisional application No. 60/469,749, filed on May 12, 2003.

(51) Int. Cl. G01B 5/00

(52) U.S. Cl. 33/542

(57) ABSTRACT

A measurement device for use with an underground flow system comprises a variable length body, a length sensor for sensing a length of extension of the body, an angle sensor for sensing an angle of inclination of the body, and a computer. The computer is used to determine at least one of a depth and a diameter of an underground pipe of the underground flow system based on readings taken from the length sensor and the angle sensor. An associated method is disclosed.

This application claims priority under 35 U. S. C. §119(e) to U.S. Provisional Application No. 60/469,749, filed May 12, 2003, which is expressly incorporated by reference herein.

### BACKGROUND

The present disclosure relates to a measurement device for use with an underground flow system. An associated method is disclosed.

### SUMMARY

A measurement device is provided for use with an underground flow system comprising an underground pipe and a ground-level opening into the underground flow system. The measurement device comprises a variable length body, a length sensor, an angle sensor, and a computer. The variable length body is positionable through the ground-level opening into the underground flow system to reach locations associated with the underground pipe. The length sensor is arranged for sensing a length of extension of the body. The angle sensor is arranged for sensing an angle of inclination of the body. The computer is used to selectively determine a depth and a diameter of the underground pipe based on readings taken from the length sensor and the angle sensor. An associated method is disclosed.

Additional features of the disclosure will become apparent to those skilled in the art upon consideration of the following description exemplifying the best mode of carrying out the disclosure as presently perceived.

### BRIEF DESCRIPTION OF THE DRAWINGS

The detailed description particularly refers to the following figures in which:

FIG. 1 is a perspective view of a measurement device in a retracted position;

FIG. 2 is a perspective view of the measurement device in an expanded position;

FIG. 3 is a side elevation view showing use of the measurement device to determine the depth of a bottom portion of an underground pipe of an underground flow system;

FIG. 4 is a perspective view showing display of the depth of the bottom portion of the pipe by a display of the measurement device;

FIG. 5 is a side elevation view showing use of the measurement device to determine the depth of a top portion of the pipe;

FIG. 6 is a perspective view showing display of the bottom portion depth (“depth1”), the top portion depth (“depth2”), and the diameter of the pipe determined from the bottom and top portion depths;

FIG. 7 is a diagrammatic view showing internal components of the measurement device; and

FIG. 8 is a sectional view taken along lines 8-8 of FIG. 1 showing a way to connect telescoping sections of the measurement device.

### DETAILED DESCRIPTION

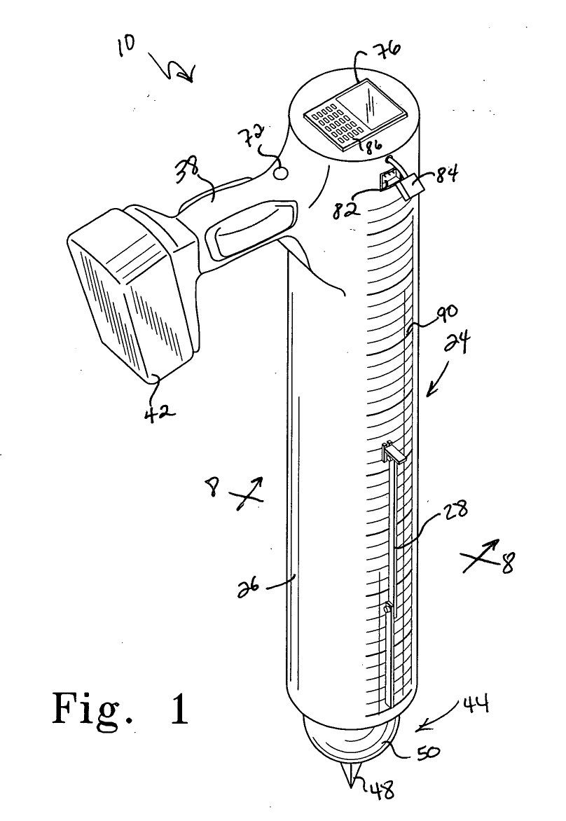

A measurement device 10 shown, for example, in FIGS. 1-3 is useful for measuring depth and diameter of an underground pipe 12 of an underground flow system 14 (e.g., stormwater system and/or sanitary sewer system). Such information is useful for managing flow through system 14.

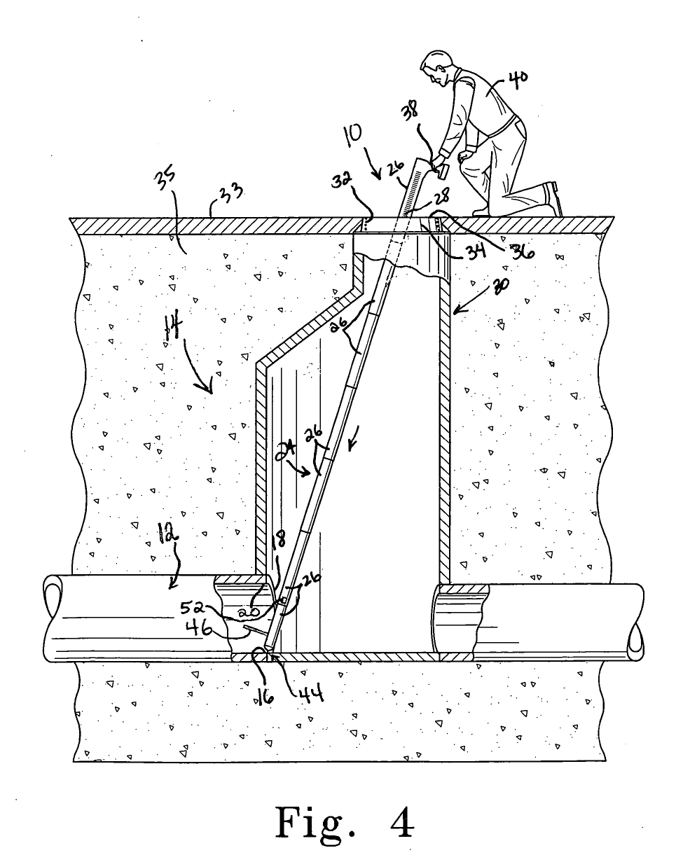

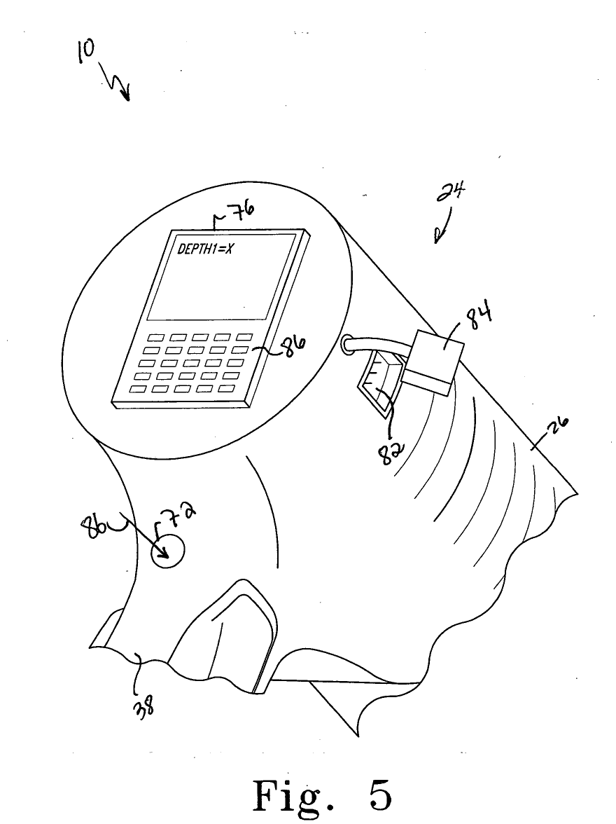

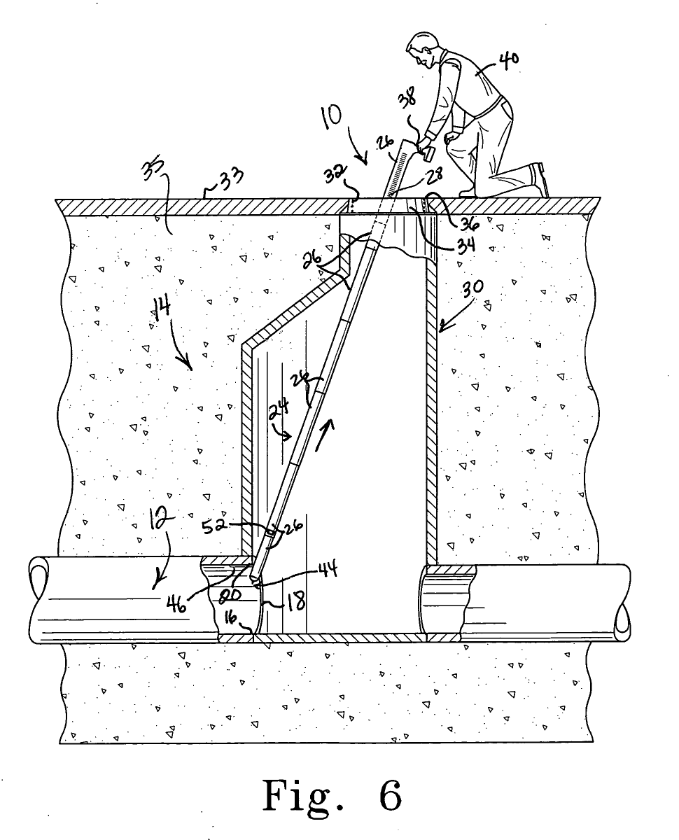

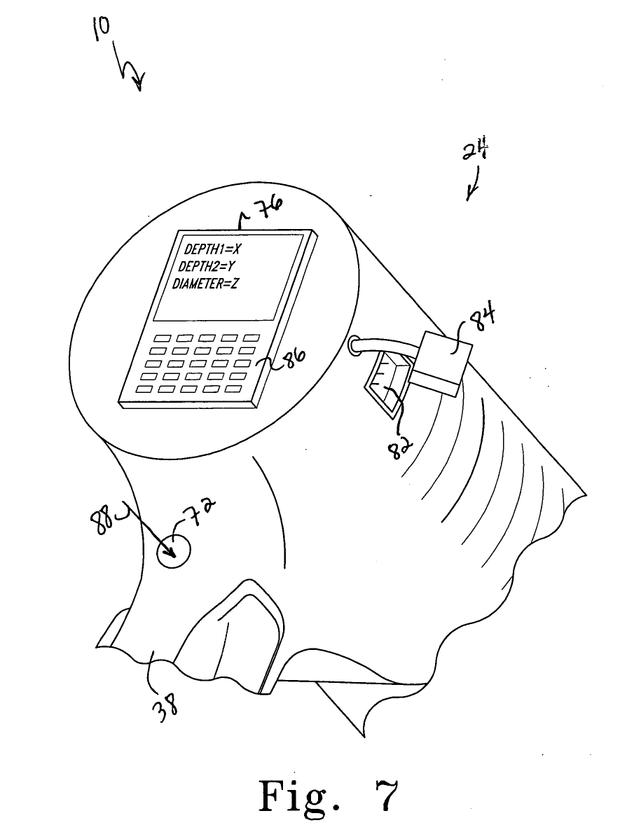

Device 10 is selectively operable in a depth mode and a diameter mode. In the depth mode, device 10 is used to obtain a single depth measurement of a portion of pipe 12 such as the bottom portion 16 of the mouth 18 of pipe 12, as suggested in FIGS. 4 and 5. In the diameter mode, device 10 is used to obtain the diameter of mouth 18 of pipe 12 by obtaining the depth of bottom portion 16 (“depth 1”), as suggested in FIGS. 4 and 5, obtaining the depth of a top portion 20 of mouth 18 of pipe 12 (“depth2”), as suggested in FIGS. 6 and 7, and determining the diameter based on the two depth measurements.

Device 10 comprises a variable length body 24, as shown, for example, in FIGS. 1, 2, 4, and 5. Body 24 is expandable to the expanded position and retractable to the retracted position. To do so, body 24 is configured, for example, as a telescopic pole comprising a plurality (e.g., seven) of telescoping sections 26. Sections 26 can be expanded and retracted manually and each section 26 is configured, for example, as a cylindrical sleeve. When a section 26 is fully expanded, it automatically locks into place by use of, for example, one or more buttons (not shown) mounted inside the section 26 and spring-biased to extend through corresponding openings (not shown) formed in immediately adjacent sections 26 when the corresponding openings become aligned with one another.

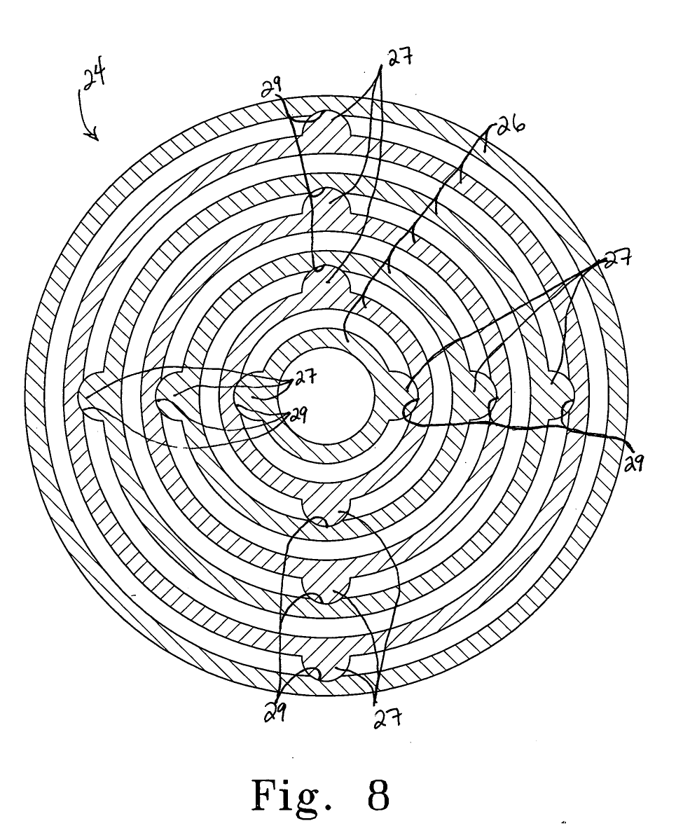

To facilitate expansion and retraction of sections 26, each section 26 comprises a pair of tabs 27 and/or a pair of grooves 29 for receiving tabs 27 of immediately adjacent sections 26, as shown, for example, in FIG. 8. Tabs 27 and grooves 29 cooperate to align sections 26 during expansion and retraction of sections 26. The top section 26 (which is the outermost section 26 in FIG. 8) comprises a pair of grooves 29 but no tabs 27. The bottom section 26 (which is the innermost section 26 in FIG. 8) comprises a pair of tabs 27 but no grooves 29. The remaining sections 26 comprise both tabs 27 and grooves 29. It is within the scope of this disclosure for sections 26 to be without tabs 27 and grooves 29.

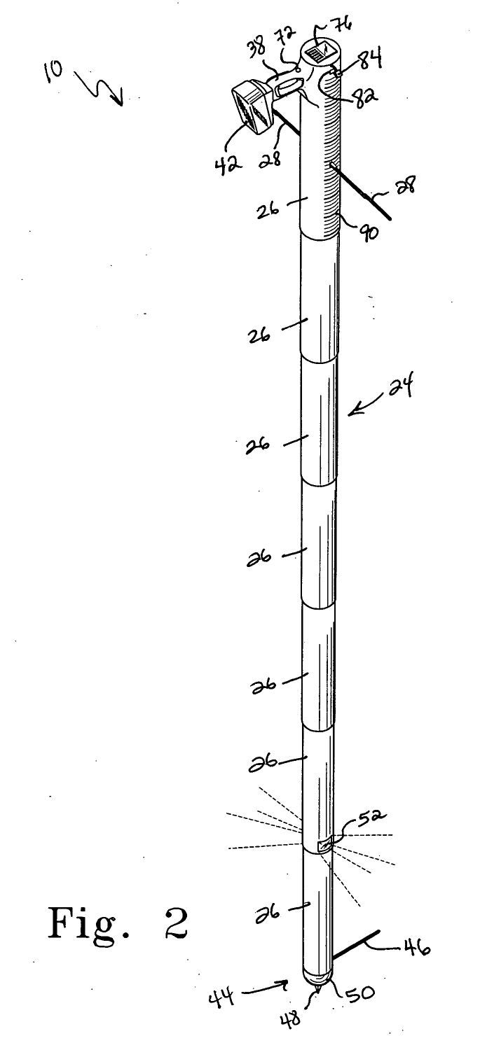

A pair of foldable stabilizer arms 28 are coupled to opposite sides of the top section 26 of body 24 to promote vertical stabilization of body 24, as shown, for example, in FIGS. 1 and 2. Arms 28 are lockable into an unfolded position shown in FIG. 2 to rest on a structure 30 when body 24 is positioned into system 14 through a ground-level opening 32 defined by structure 30 and located at or near ground level. For purposes of this disclosure, it is to be understood that the term “ground level” (or “ground-level”) refers to the level at or near the level of the external surface 33 of the material 35 (e.g., soil, rock, asphalt, concrete) surrounding system 14. Structure 30 may be a manhole comprising a riser 34 that normally receives a manhole cover (not shown) and comprises a rim 36 that defines opening 32 and on which arms 28 rest when the manhole cover is removed and body 24 is positioned through opening 32, as shown, for example, in FIGS. 4 and 6. It is within the scope of this disclosure for structure 30 to be a stormwater inlet (normally covered, for example, by a grate), a catch basin, and the like.

A handle 38 is coupled to the top section 26 of body 24 for a person 40 to hold and manipulate device 10, as shown, for example, in FIGS. 1, 4, and 5. A rechargeable battery 42 is coupleable to handle 38 for providing electrical power to the electrical components of device 10.

First and second positioners 44, 46 are used for positioning body 24 relative to bottom and top portions 16, 20, as shown, for example, in FIG. 2. First positioner 44 comprises a metal spike 48 extending from a rubber heel cap 50 coupled to the bottom section 26 and is used to position body 24 at a first location associated with bottom portion 16 when the depth of bottom portion 16 is being evaluated. Second positioner 46 is configured, for example, as an anchor arm pivotably coupled to the bottom section 26 and engageable with top portion 20 to anchor body 24 at a second location associated with top portion 20, as shown, for example, in FIG. 6. Arm 46 is captured between the bottom two sections 26 when body 24 is retracted to the retracted position and is released from between those two sections 26 for pivotable movement when body 24 is expanded.

A pair of lights 52 shown, for example, in FIG. 2 are used to illuminate the interior of system 14. Lights 52 are coupled to opposite sides of the section 26 just above the bottom section 26.

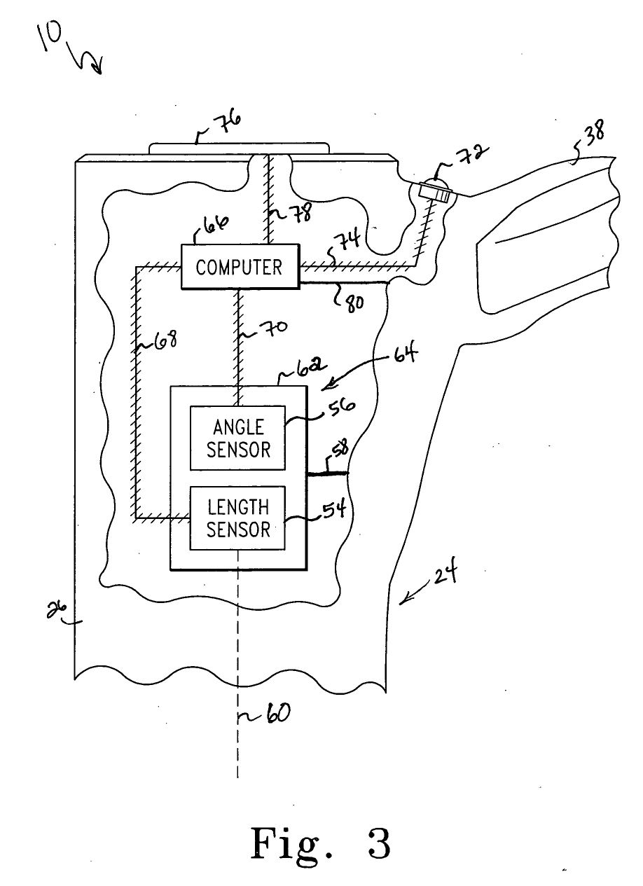

Device 10 comprises a length sensor 54 and an angle sensor 56, as shown, for example, in FIG. 3. Length sensor 54 is arranged for sensing a length of extension of body 24 when body 24 is extended to the first and second locations associated with bottom and top portions 16, 20, respectively. Length sensor 54 is configured, for example, as a laser which generates a laser beam 60 that reflects from a surface of the bottom section 26 (or other surface associated with the bottom section) to determine the length of extension of body 24.

Angle sensor 56 is arranged for sensing an angle of inclination of body 24 when body 24 is extended to the first and second locations. For purposes of this disclosure, it is to be understood that each “angle of inclination” is measured from vertical (the angle of inclination may also be referred to as a tilt angle). Angle sensor 56 is configured, for example, as one or more digital inclinometers.

Illustratively, sensors 54, 56 are packaged in a common housing 62 to provide a combination sensor unit 64. The unit 64 is positioned inside the top section 26 of body 24 and coupled to the top section 26 by a sensor mount 58. The Advantage System available from Laser Atlanta, LLC of Norcross, Ga. is an example of a combination sensor unit with a laser for length measurement and a digital inclinometer for angle of inclination measurement. It is within the scope of this disclosure for sensors 54, 56 to be separate from one another. In such a case, a separate laser (e.g., Leica DISTO™ lite) for length measurement is available from Leica Geosystems AG of St. Gallen, Switzerland. Separate digital inclinometers are available from RST Instruments Ltd. of British Columbia, Canada (e.g., the RST Digital Inclinometer) and from Reiker, Inc. of Folcroft, Pa. (e.g., the RDI Series).

A computer 66 is used to determine the depths of the bottom and top portions 16, 20 and the diameter of mouth 18 based on information from length and angle sensors 54, 56. Computer 66 is electrically coupled to length sensor 54 via a length signal line 68 to receive length signals generated by length sensor 54 and representative of lengths of extension of body 24. Computer 66 is electrically coupled to angle sensor via an angle signal line 70 to receive angle sensors generated by angle sensor 56 and representative of angles of inclination of body 24. Computer 66 is electrically coupled to an input control 72 via a control signal line 74 so as to be responsive to actuations of input control 72 to take readings from sensors 54, 56 (i.e., to receive length and angle signals from sensors 54, 56). Computer 66 is electrically coupled to a display 76 via a display signal line 78 to transmit display signals to display 76 to cause display 76 to display information such as the depth of bottom portion 16 (see FIG. 5) and the depth of top portion 20 and diameter of mouth 18 (see FIG. 7).

Computer 66 comprises a processor (not shown), such as a microprocessor, and a memory (not shown). The memory has instructions to cause the processor to perform the functions of computer 66 such as calculations to determine the depths and diameter in response to actuations of input control 72.

Computer 66 is positioned in the top section 26 of body 24, as shown, for example, in FIG. 3. Computer 66 is coupled to the top section 26 by a computer mount 80. It is within the scope of this disclosure for computer 66 to be external to body 24 and coupleable to sensors 54, 56, input control 72, and display 76 via a data communication port 82 coupled to the top section 26 of body 24 and normally covered by a cover 84 when not being used.

In use, person 40 operates a keypad 86 to select either the depth mode or the diameter mode. Computer 66 further prompts person 40 to select whether length measurements are to be taken from stabilizer arms 28, such as when stabilizer arms 28 are positioned on rim 36 to vertically stabilize the length measurement reference point at the same level as rim 36, or to be taken from the top of the top section 26 of body 24, such as when arms 28 are not used and body 24 is advanced farther into system 14 so that the top of the top section 26 is at the same level as rim 36 to provide extra length.

In both modes, body 24 is positioned through ground-level opening 32 into system 14. Sections 26 are expanded as needed so that spike 48 reaches the first location at bottom portion 16 of mouth 18 of pipe 12, as shown, for example, in FIG. 4. As mentioned above, stabilizer arms 28 may be placed on rim 36 to vertically stabilize the length measurement reference point at the level of the rim 36 while the readings are taken. Once spike 48 is secured in position at the first location, person 40 actuates input control 72 a first time 86, as shown, for example, in FIG. 5. Such actuation of input control 72 causes length sensor 54 to send to computer 66 over length signal line 68 a first length signal representative of a first length of extension of body 24 and causes angle sensor 56 to send to computer 66 over angle signal line 70 a first angle signal representative of a first angle of inclination of body 24. Computer 66 determines the depth of bottom portion 16 in response to the first length signal and the first angle signal and sends a signal over display signal line 78 to cause display 76 to display this depth, as shown, for example, in FIG. 5. The depth mode process ends at this point if depth mode was selected. However, if diameter mode was selected, the process continues with measurement of the depth of top portion 20.

To obtain the depth of top portion 20, person 40 manually retracts body 24 to cause anchor arm 46 to become flush with the inner surface of top portion 20 so that body 24 is positioned at the second location, as shown, for example, in FIG. 6. Once anchor arm 46 is secured in such a position, person 40 actuates input control 72 a second time 88, as shown, for example, in FIG. 7. Such actuation of input control 72 causes length sensor 54 to send to computer 66 over length signal line 62 a second length signal representative of a second length of extension of body 24 and causes angle sensor 56 to send to computer 66 over angle signal line 70 a second angle signal representative of a second angle of inclination. Computer 66 determines the depth of top portion 20 in response to the second length signal and the second angle signal.

Computer 66 uses the depth of bottom portion 16 and the depth of top portion 20 to determine the diameter of mouth 18 of pipe 12. In particular, computer 66 subtracts the depth of top portion 20 from the depth of bottom portion 16 to obtain the diameter. Computer 66 sends one or more signals over display signal line 78 to cause display 76 to display both depths and the diameter, as shown, for example, in FIG. 7.

Distance measurement markings 90 are added to the outer surface of the top section 26 of body 24 to facilitate manual depth measurements of underground structures located relatively close to opening 32.

1. A method comprising the acts of
longitudinally extending a variable length body in an underground flow system a first length and at a first angle of inclination to a first location associated with a first portion of an underground pipe of the underground flow system,
sensing the first length and generating a first length signal in response thereto,
sensing the first angle and generating a first angle signal in response thereto, and
determining a first depth associated with the first portion of the pipe in response to the first length signal and the first angle signal.

2. The method of claim 1, wherein the first portion is a bottom portion of the pipe, further comprising the acts of
longitudinally extending the body in the underground flow system a second length and at a second angle of inclination to a second location associated with a top portion of the pipe,
sensing the second length and generating a second length signal in response thereto,
sensing the second angle and generating a second angle signal in response thereto,
determining a second depth associated with the top portion of the pipe in response to the second length signal and the second angle signal, and
determining a diameter of the pipe based on the first depth and the second depth.

3. The method of claim 1, wherein the body is configured as a telescopic pole, and the act of longitudinally extending the body to the first location comprises increasing the length of the telescopic pole.

4. The method of claim 1, wherein the acts of generating the first length signal and the first angle signal occur in response to actuating an input control a single time.

5. The method of claim 1, wherein the underground flow system comprises a rim comprising a ground-level opening into the underground flow system, further comprising positioning a stabilizer arm coupled to the body on the rim.

6. The method of claim 1, wherein the underground flow system comprises a ground-level opening into the underground flow system, and the extending act comprises extending the body through the ground-level opening into the underground flow system.

7. A method comprising the acts of
longitudinally extending a variable length body in an underground flow system a first length and at a first angle of inclination to a first location associated with a bottom portion of an underground pipe associated with the manhole,
sensing the first length and generating a first length signal in response thereto,
sensing the first angle and generating a first angle signal in response thereto,
longitudinally extending the body in the underground flow system a second length and at a second angle of inclination to a second location associated with a top portion of the pipe,
sensing the second length and generating a second length signal in response thereto,
sensing the second angle and generating a second angle signal in response thereto, and
determining a diameter of the pipe in response to the first and second length signals and the first and second angle signals.

8. The method of claim 7, wherein the body is configured as a telescopic pole, the act of longitudinally extending the body to the first location comprises increasing the length of the telescopic pole, and the act of longitudinally extending the body to the second location comprises decreasing the length of the telescopic pole.

9. The method of claim 7, wherein the acts of generating the first length signal and the first angle signal occur in response to actuating an input control a first time and the acts of generating the second length signal and the second angle signal occur in response to actuating the input control a second time.

10. The method of claim 7, wherein the act of longitudinally extending the body to the second location comprises causing an anchor arm coupled to the body to engage the top portion of the pipe to anchor the body adjacent to the top portion.

11. The method of claim 7, further comprising displaying the diameter.

12. The method of claim 7, wherein the underground flow system comprises a ground-level opening into the underground flow system, and both extending acts comprise extending the body through the ground-level opening into the underground flow system.

13. A measurement device for use with an underground flow system comprising an underground pipe and a ground-level opening into the underground flow system, the measurement device comprising
a variable length body positionable through the ground-level opening into the underground flow system,
a length sensor arranged for sensing a first length of extension of the body when the body is extended to a first location associated with the pipe,
an angle sensor arranged for sensing a first angle of inclination of the body when the body is extended to the first location, and
a computer programmed for determining a first depth associated with the pipe based on a first length signal sent from the length sensor and representative of the first length and a first angle signal sent from the angle sensor and representative of the first angle.

14. The measurement device of claim 13, wherein the first location and the first depth are associated with a bottom portion of the pipe, the length sensor is arranged for sensing a second length of extension of the body when the body is extended to a second location associated with a top portion of the pipe, the angle sensor is arranged for sensing a second angle of inclination of the body when the body is extended to the second location, and the computer is programmed for determining a second depth associated with the top portion based on a second length signal sent from the length sensor and representative of the second length and a second angle signal sent from the angle sensor and representative of the second angle and is programmed for determining the diameter of the pipe based on the first depth and the second depth.

15. The measurement device of claim 14, wherein the computer is programmed to selectively operate in a depth mode and a diameter mode, the computer is programmed to determine the first depth but not the second depth and the diameter when the computer is operated in the depth mode and to determine the first depth, the second depth, and the diameter when the computer is operated in the diameter mode.

16. The measurement device of claim 13, wherein the body is configured as a telescopic pole, and the length sensor and the angle sensor are coupled to the telescopic pole.

17. The measurement device of claim 16, wherein the length sensor comprises a laser positioned inside the telescopic pole.

18. The measurement device of claim 13, wherein the body is configured as a telescopic pole, further comprising a handle coupled to the telescopic pole.

19. The measurement device of claim 13, further comprising a pair of stabilizer arms, wherein the body is configured as a telescopic pole, and the stabilizer arms are coupled to the telescopic pole and configured to rest on a rim defining the ground-level opening to promote vertical stabilization of the telescopic pole.

20. The measurement device of claim 13, further comprising a battery coupled to the body.

21. The measurement device of claim 13, wherein the computer is coupled to the body.

22. The measurement device of claim 13, further comprising a data communication port coupled to the body.

23. The measurement device of claim 13, further comprising a light, wherein the body is configured as a telescopic pole comprising a plurality of telescoping sections, and the light is coupled to one of the telescoping sections.

24. The measurement device of claim 13, further comprising a display electrically coupled to the computer.

25. A measurement device for use with an underground flow system comprising an underground pipe and a ground-level opening into the underground flow system, the measurement device comprising
a variable length body positionable through the ground-level opening into the underground flow system,
a length sensor for sensing a first length of extension of the body when the body is extended to a first location associated with a bottom portion of the pipe and a second length of extension of the body when the body is extended to a second location associated with a top portion of the pipe,
an angle sensor for sensing a first angle of inclination of the body when the body is extended to the first location and a second angle of inclination of the body when the body is extended to the second location, and
a computer programmed for determining the diameter of the pipe based on a first length signal sent from the length sensor and representative of the first length, a second length signal sent from the length sensor and representative of the second length, a first angle signal sent from the angle sensor and representative of the first angle, and a second angle signal sent from the angle sensor and representative of the second angle.

26. The measurement device of claim 25, further comprising an anchor arm, wherein the body is configured as a telescopic pole, and the anchor arm is coupled to the telescopic pole for engaging the top portion of the pipe to anchor the telescopic pole when the telescopic pole is extended to the second location.

27. The measurement device of claim 25, wherein the body is configured as a telescopic pole, and the length sensor and the angle sensor are positioned inside the telescopic pole.

28. The measurement device of claim 25, further comprising an input control for obtaining the first length and the first angle in response to a first actuation of the input control and for obtaining the second length and the second angle in response to a second actuation of the input control.
